(19) United States
(12) Patent Application Publication
(10) Pub. No.: US 2026/0012842 A1
(43) Pub. Date: Jan. 8, 2026

(54) PROTOCOL DATA UNIT (PDU) SET HANDLING CAPABILITY INDICATION

(71) Applicant: Lenovo (Beijing) Limited, Beijing (CN)

(72) Inventors: Haiyan Luo, Shanghai (CN); Mingzeng Dai, Shanghai (CN); Tingfang Tang, Beijing (CN); Congchi Zhang, Shanghai (CN); Xiaoying Xu, Shanghai (CN)

(73) Assignee: Lenovo (Beijing) Limited, Beijing (CN)

(21) Appl. No.: 18/881,951

(22) PCT Filed: Jul. 8, 2022
(86) PCT No.: PCT/CN2022/104637

§ 371 Date: Jan. 7, 2025

(51) Int. Cl. H04W 28/02; H04W 76/11; H04W 76/12

(52) U.S. Cl. CPC H04W 28/0268; H04W 76/11; H04W 76/12

(57) ABSTRACT

Method and apparatus for PDU set handling capability indication are disclosed. In one embodiment, session management function (SMF) comprises a processor and a transceiver coupled to the processor, wherein the processor is configured to determine PDU set handling capability of a RAN node; and transmit, via the transceiver, to UPF, an indication of activating or deactivating PDU set handling for PDU session or QoS flow (s) according to the PDU set handling capability of the RAN node to which the UPF is connected.

### FIELD

The subject matter disclosed herein generally relates to wireless communications, and more particularly relates to PDU set handling capability indication for XR traffic.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Extended Reality (XR), Augmented Reality (AR), Virtual Reality (VR), Cloud Gaming (CG), Protocol Data Unit (PDU), XR and Media service (XRM), Quality of Service (QOS), Application Function (AF), service data flow (SDF), Internet Protocol (IP), User Plane Function (UPF), intermediate UPF (I-UPF), Radio Access Network (RAN), PDU Session Anchor (PSA), GPRS Tunnelling Protocol User Plane (GTP-U), Packet Flow Description (PFD), Packet Flow Description Function (PFDF), PDU Set Delay Budget (PSDB), PDU Set Error Rate (PSER), Session Management Function (SMF), 5G System (5GS), Policy Control Function (PCF), Network Exposure Function (NEF), Technical Specification (TS), Policy and Charging Control (PCC), Packet Flow Description (PFD), Unified Data Repository (UDR), Operations and Maintenance (OAM), Single Network Slice Selection Assistance Information (S-NSSAI), Data Network Name (DNN), Evolved Universal Terrestrial Radio Access (E-UTRA), Cell Global Identifier (CGI), Access and Mobility Management Function (AMF), Tracking Arca Identity (TAI), Network repository function (NRF), Access Stratum (AS), Non Access Stratum (NAS), QoS Flow ID (QFI), Information Element (IE), 5G core (5GC), serial number (SN), Core network (CN), Data Network (DN).

Extended Reality (XR), including Augmented Reality (AR) and Virtual Reality (VR), as well as Cloud Gaming (CG), are important media applications for 5G.

A PDU Set is composed of one or more PDUs carrying the payload of one unit of information generated at the application level (e.g., a frame or video slice for XRM Services), which are of same importance requirement at application layer. All PDUs in a PDU Set are needed by the application layer to use the corresponding unit of information. In some cases, the application layer can still recover parts of the information unit, even if some PDUs are missing.

For XR and media service, it is proposed to support PDU set integrated packet handling and differentiated QoS handling.

PDU set integrated packet handling means that group of packets belonging to a same PDU set will be handled in an integrated manner. For example, the 5G system may drop some packet(s) but try to deliver other packets of the same PDU set. Due to the dropped packet(s), the other delivered packets may be useless to the client and thus waste radio resources. Therefore, if one or more (e.g. certain number of or a certain ratio of) PDU(s) of a PDU set has been lost, the remaining PDUs of the PDU set are useless for application layer, which should not be transmitted over air interface.

Differentiated QoS handling is based on importance of PDU set. For example, the packets (i.e. PDUs) belonging to less important PDU set(s) can be treated differently to reduce the resource wasting. For example, the less importance PDU set(s) can be dropped if congestion occurs.

This invention targets PDU set handling capability indication.

### BRIEF SUMMARY

Method and apparatus for PDU set handling capability indication are disclosed.

In one embodiment, SMF comprises a processor and a transceiver coupled to the processor, wherein the processor is configured to determine PDU set handling capability of a RAN node; and transmit, via the transceiver, to UPF, an indication of activating or deactivating PDU set handling for PDU session or QoS flow(s) according to the PDU set handling capability of the RAN node to which the UPF is connected.

In some embodiment, the PDU set handling comprises PDU set identification and GTP-U header marking at PSA UPF, or GTP-U header marking at intermediate UPF.

In some embodiment, the PDU set handling capability of the RAN node is determined based on at least one of RAN node's ID, area information, and a combination of DNN and S-NSSAI.

In some embodiment, the PDU set handling capability of the RAN node is determined by retrieving the PDU set handling capability of the RAN node from NRF.

In some embodiment, the PDU set handling capability of the RAN node is determined by receiving, via the transceiver, the PDU set handling capability of the RAN node during PDU session establishment procedure.

In some embodiment, the PDU set handling capability of RAN node is determined as not support of PDU set integrated packet handling by receiving, via the transceiver, an indication that unknown GTP-U extension header is found.

In some embodiment, the PDU set handling capability of the RAN node is determined by receiving, via the transceiver, the PDU set handling capability of the RAN node contained in Path Switch Request Transfer.

In some embodiment, the RAN node is a target RAN node in Handover, and if the processor determines that the PDU set handling capability of the target RAN node is different from the PDU set handling capability of a source RAN node, the indication is transmitted to the UPF.

In some embodiment, the PDU set handling capability of a secondary RAN node is determined by receiving, via the transceiver, the PDU set handling capability of the secondary RAN node from a master RAN node.

In some embodiment, the processor is further configured to send, via the transceiver, to the RAN node, an indication of whether PDU set handling is necessary.

In another embodiment, a method at SMF comprises determining PDU set handling capability of a RAN node; and transmitting, to UPF, an indication of activating or deactivating PDU set handling for PDU session or QoS flow(s) according to the PDU set handling capability of the RAN node to which the UPF is connected.

In yet another embodiment, a network node (e.g. RAN node) of a network architecture comprises: a processor and a transceiver coupled to the processor, wherein the processor is configured to transmit, via the transceiver, PDU set handling capability of the RAN node to a core network node.

In some embodiment, the PDU set handling capability of the RAN node is transmitted to SMF via AMF.

In some embodiment, the PDU set handling capability of the RAN node is transmitted in response to a request from SMF.

In some embodiment, the PDU set handling capability of the RAN node is transmitted to UPF or SMF in response to receiving a DL packet which contains unknown new GTP-U extension header.

In some embodiment, the PDU set handling capability of the RAN node is transmitted in response to at least one of: receiving XR specific information contained in Handover Request; receiving an indication of providing PDU set handling capability; and determining that the PDU set handling capability of the RAN node is different from the PDU set handling capability of source RAN node in Handover.

In some embodiment, the processor is further configured to transmit, via the transceiver, PDU set handling capability of a secondary RAN node to the core network node.

In further embodiment, a method at RAN node comprises transmitting PDU set handling capability of the RAN node to a core network node.

### BRIEF DESCRIPTION OF THE DRAWINGS

A more particular description of the embodiments briefly described above will be rendered by referring to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a first sub-embodiment of a third embodiment;

FIG. 2 illustrates a second sub-embodiment of the third embodiment;

FIG. 3 illustrates a third sub-embodiment of the third embodiment;

FIG. 4 illustrates a fourth sub-embodiment of the third embodiment;

FIG. 5 illustrates a first sub-embodiment of a fourth embodiment;

FIG. 6 illustrates a second sub-embodiment of the fourth embodiment;

FIG. 7 illustrates a first sub-embodiment of a fifth embodiment;

FIG. 8 illustrates a second sub-embodiment of the fifth embodiment;

FIG. 9 illustrates a sixth embodiment;

FIG. 10 is a schematic flow chart diagram illustrating an embodiment of a method;

FIG. 11 is a schematic flow chart diagram illustrating a further embodiment of a method; and

FIG. 12 is a schematic block diagram illustrating another apparatus according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”. “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Before describing the procedures of this disclosure, a summary of the delivering of the XR traffic, which can be traffic generated by XR, CG application or other kind of media application, is described.

The XR traffic is originated and transmitted from application server to UPF, and transported by service data flow (SDF) or IP packet flow. Each packet is a PDU.

A PDU session is established between UPF and UE. Different QoS flows can be present in the established PDU session. Generally, the XR traffic is transported in QoS flow(s) of the PDU session, from UPF to RAN node (e.g. NR-RAN node: gNB, or LTE node: NB) and from RAN node to UE. There can be intermediate UPF(s) (I-UPF) between UPF (which is referred to as PSA UPF) and RAN node.

PDU set handling at RAN node means that RAN node can perform PDU set integrated packet handling and differentiated QoS handling.

In order for a RAN node to perform PDU set handling (i.e. PDU set integrated packet handling and differentiated QoS handling) for a specific traffic (e.g. XR and media traffic, which can be referred to as XR traffic hereinafter), UPF to which the RAN node connects needs to perform PDU set identification and marking of the specific traffic (referred as PDU set handling at UPF). It means that UPF needs to identify the PDUs of one PDU set that the RAN node performs PDU set handling, and mark them for the RAN node. For example, UPF acquires PDU set related information (e.g. PDU set serial number, start and/or end indications, PDU serial number within PDU set, importance, dependency, etc.) of the specific traffic (e.g. XR and media traffic) by reading RTP and/or SRTP header and/or payload of the PDU set carrying the specific traffic or based on implementation, and inserts the acquired PDU set related information into GTP-U extended header of N3 interface (i.e. interface between RAN node and UPF) and/or N9 interface (i.e. interface between UPFs). So, PDU set handling at UPF means PDU set identification and GTP-U header marking performed at UPF. The RAN node can perform PDU set handling (i.e., PDU set integrated packet handling and differentiated QoS handling) for the PDUs, where the PDU set related information is contained in the GTP-U extended header of each of the PDUs.

This disclosure proposes that AF may indicate whether PDU set handling is necessary for XR traffic, or that PDU set handling is not necessary for XR traffic. It means that PDU set handling may be not necessary (e.g. by indication from AF, or by default), or PDU set handling may be necessary (e.g. by indication from AF).

Incidentally, if AF provides an indication of whether PDU set handling is necessary, the indication can be associated with at least one of specific application identifier, specific flow description and specific Packet Flow Description (PFD). For example, a new IE (e.g. indication of whether PDU set handling is necessary) can be introduced in AF request. The value of the indication can be ‘1’ (or ‘true’), which indicates PDU set handling is necessary, or ‘0’ (or ‘false’), which indicates PDU set handling is not necessary. Alternatively, an existing IE “PDU Set handling indication” can be reused to indicate whether PDU set handling is necessary. For example, if PDU set handling indication is included in AF request, it means that PDU set handling is necessary for the associated traffic (e.g. XR traffic); while if it is not included in AF request, it means that PDU set handling is not necessary for the associated traffic.

If PDU set handling is not necessary for XR traffic, the XR traffic can be transmitted without PDU set handling. In other words, for XR traffic, it is acceptable that UPF does not perform PDU set identification and GTP-U header marking, and accordingly, RAN node does not perform PDU set integrated packet handling and differentiated QoS handling.

On the other hand, if PDU set handling is necessary for XR traffic, UPF shall perform PDU set identification and GTP-U header marking (i.e. PDU set handling at UFP), and RAN node shall perform PDU set integrated packet handling and differentiated QoS handling (i.e. PDU set handling at RAN node). However, some RAN nodes may not support PDU set handling. It implies that the RAN node that does not support PDU set handling cannot handle the XR traffic for which PDU set handling is necessary.

RAN node that does not support PDU set handling cannot handle XR traffic. On the other hand, if PDU set handling is not necessary for XR traffic, the RAN node that does not support PDU set handling can transmit the XR traffic without PDU set handling. This disclosure proposes that whether RAN node supports PDU set handling at

RAN node can be considered as a capability of the RAN node or a preference of the RAN node (e.g. based on network load or performance of the RAN node). The PDU set handling capability can be indicated as ‘true’ (or ‘1’) which means support of PDU set handling, or be indicated as ‘false’ (or ‘0’) which means not support of PDU set handling.

Incidentally, PDU set handling capability may be extended as PDU set handling capability information. The PDU set handling capability information includes, in addition to PDU set handling capability (which indicates whether RAN node supports PDU set handling), the type of PDU set handling (if the PDU set handling capability indicates that RAN node supports PDU set handling). The type of PDU set handling may for example be 1) packets of one PDU set type or packets with the same importance value in one QoS flow; or 2) packets of more than one PDU set types or packets with different importance values in one QoS flow. It is obvious that only when the PDU set handling capability is ‘true’ (i.e. support of the PDU set handling), the type of PDU set handling can be further indicated. In the following description, when the PDU set handling capability is indicated as ‘true’, it is assumed that the type of PDU set handling can be further indicated.

In this disclosure, RAN node can be classified into three types.

Type #1 RAN node does not understand additional signaling and/or IEs introduced for XR traffic, and accordingly does not support PDU set handling at RAN node. LTE eNB and legacy NR gNB may be examples of type #1 RAN node. Examples of additional signaling and/or IEs are PDU Set Delay Budget (PSDB), and PDU Set Error Rate (PSER), etc. These additional IEs can be regarded as unknown IEs for type #1 RAN node. Type #1 RAN node may reject or ignore the unknown IEs.

Type #2 RAN node understands additional signaling and/or IEs introduced for XR traffic, but does not support PDU set handling at RAN node or does not prefer PDU set handling at RAN node due to network conditions. Type #2 RAN node may ignore the additional signaling and/or IEs introduced for XR traffic. In other words, type #2 RAN node handles XR traffic (for which PDU set handling is not necessary) without PDU set handling.

Type #3 RAN node understands additional signaling and/or IEs introduced for XR traffic, and supports PDU set handling at RAN node.

It is assumed that UPF can always support PDU set handling at UPF. It means that UPF can perform PDU set handling at UPF or not perform PDU set handling at UPF. If PDU set handling at RAN node is supported at the RAN node to which UPF is connected, UPF shall perform PDU set handling at UPF (e.g. PDU set identification and GTP-U header marking). Furthermore, if RAN node provides the type of PDU set handling, SMF informs UPF to perform packet detection and forwarding based on the type of PDU set handling. For example, if RAN node supports type 1) packets of one PDU set type or packets with the same importance value in one QoS flow, SMF configures the importance value associated with QFI. That is, UPF shall read the importance value of DL packet, and marks the packet with the corresponding QFI. In this way, SMF informs RAN node of the mapping relationship between importance value and QFI. Then, the importance value is not necessary to be inserted in the extended GTP-U header towards RAN node. If RAN node supports type 2) packets of more than one PDU set types or packets with different importance values in one QoS flow, UPF shall read the importance value of DL packet, and insert importance value into the extended GTP-U header towards RAN node. In this way, RAN node is able to acquire the importance value of DL packet from extended GTP-U header. Otherwise (it means that PDU set handling at RAN node is not supported at the RAN node to which UPF is connected), UPF shall not perform PDU set handling at UPF. Further, if the PDU set handling is necessary for a specific traffic (e.g. XR traffic), the RAN node that does not support PDU set handling is not eligible to handle the specific traffic.

Incidentally, it is possible that there are intermediate UPF(s) between RAN node and UPF (referred to as PSA UPF in this condition). The intermediate UPF shall perform GTP-U header marking if the PSA UPF performs PDU set handling, and shall not perform GTP-U header marking if the PSA UPF does not perform PDU set handling. The GTP-U header marking at intermediate UPF can also be referred to as PDU set handling at UPF.

In order to enable adaptive PDU set handling at UPF (that is, if PDU set handling at RAN node is supported at the RAN node to which UPF is connected, UPF performs PDU set handling at UPF, and if PDU set handling at RAN node is not supported at the RAN node to which UPF is connected, UPF does not perform PDU set handling at UPF), it is necessary to know whether RAN node supports PDU set handling (i.e. the PDU set handling capability of RAN node).

According to the above-described classification of RAN node, the PDU set handling capability of type #1 RAN node or type #2 RAN node is ‘false’ (i.e. not support of PDU set handling at RAN node), while the PDU set handling capability of type #3 RAN node is ‘true’ (i.e. support of PDU set handling at RAN node).

UPF obtains the PDU set handling capability of RAN node from SMF. It means that SMF shall obtain (or determine) the PDU set handling capability of the RAN node to which UPF is connected, and informs UPF to perform or to not perform PDU set handling at UPF.

SMF may obtain the PDU set handling capability of RAN node by various manners in various situations (or in various use cases).

First, as mentioned above, AF may provide the indication of whether PDU set handling is necessary, e.g. for XR traffic. SMF can know the indication of whether PDU set handling is necessary for XR traffic by one of the following manners:
Manner #1: AF provides PCF (via NEF) with the indication associated with flow description, based on the procedure of AF session with required QoS in TS 23.502 4.15.6.6, or AF influence on traffic routing in TS 23.502 4.3.6. PCF will provide SMF with the PCC rules, which contains the indication of whether PDU set handling is necessary associated with service data flow filter (e.g. for XR traffic).
Manner #2: AF provides NEF (e.g. PFDF in NEF, or NEF that has the function of PFD) with the indication of whether PDU set handling is necessary associated with application identifier and PFD, based on PFD management procedure in TS 23.502 4.18.2. NEF stores the indication of whether PDU set handling is necessary associated with application identifier and PFD in UDR. PCF provides SMF with PCC rules with application identifier. SMF retrieves the indication and PFD for the application identifier from UDR via NEF based on procedure in TS 23.502 4.18.3.

The following embodiments describe how SMF obtains (or determines) the PDU set handling capability of RAN node. The PDU set handling capability of RAN node may be ‘true’ (or ‘1’) indicating that the RAN node supports PDU set handling or ‘false’ (or ‘0’) indicating that the RAN node does not support PDU set handling. If the PDU set handling capability of RAN node is ‘true’, the type of PDU set handling can be further obtained.

According to a first embodiment, SMF may be preconfigured (e.g., by OAM) with 1) the mapping of PDU set handling capability of RAN node with RAN node ID of the RAN node, or 2) the mapping of PDU set handling capability of RAN node within an area (e.g. Tracking Area) with the area information of the area, or 3) the mapping of PDU set handling capability of RAN node with a combination of DNN and S-NSSAI (e.g. S-NSSAI, or DNN and S-NSSAI). The PDU set handling capability of each RAN node may be preconfigured. SMF checks whether a RAN node (e.g. target RAN node in handover procedure) supports PDU set handling based on at least one of (a) RAN node ID, (b) area information, and (c) a combination of DNN and S-NSSAI.

According to a first example of the first embodiment, SMF obtains RAN node ID (e.g. ng-eNB ID or gNB ID) from user location information provided by AMF or by RAN node (e.g. target RAN node in handover case). The user location information includes E-UTRA CGI for LTE and NR CGI for NR, which contains gNB ID in NR Cell Identify or ng-eNB ID in E-UTRA CGI. SMF retrieves PDU set handling capability for the RAN node ID (e.g. ng-eNB ID, gNB ID, etc) based on pre-configuration.

In a second example of the first embodiment, SMF obtains the DNN and S-NSSAI associated with XR traffic from AMF and checks whether the RAN node (e.g. target RAN node in Handover case) supports PDU set handling based on pre-configuration.

In a third example of the first embodiment, SMF obtains TAI from user location information provided by AMF or by RAN node (e.g. target RAN node in Handover case). SMF retrieves PDU set handling capability for TAI based on pre-configuration.

In the first embodiment, the PDU set handling capability of each RAN node is pre-configured in SMF. SMF identifies a RAN node (e.g. by at least one of (a) RAN node ID, (b) area information, and (c) a combination of DNN and S-NSSAI) and retrieves the PDU set handling capability of the RAN node.

According to a second embodiment, SMF may retrieve PDU set handling capability of RAN node (e.g. target RAN node) from NRF. It is assumed that AMF has provided the mapping of PDU set handling capability of RAN node with RAN node ID of the RAN node to NRF. It means that the PDU set handling capability of each RAN node is preserved in NRF. SMF sends a request with RAN node ID of a RAN node to NRF for the PDU set handling capability of the RAN node. NRF responds with the PDU set handling capability of the RAN node.

According to a third embodiment, the PDU set handling capability of RAN node can be indicated in PDU session establishment procedure.

According to a first sub-embodiment of the third embodiment, UE triggers AMF to provide PDU set handling capability of RAN node to SMF.

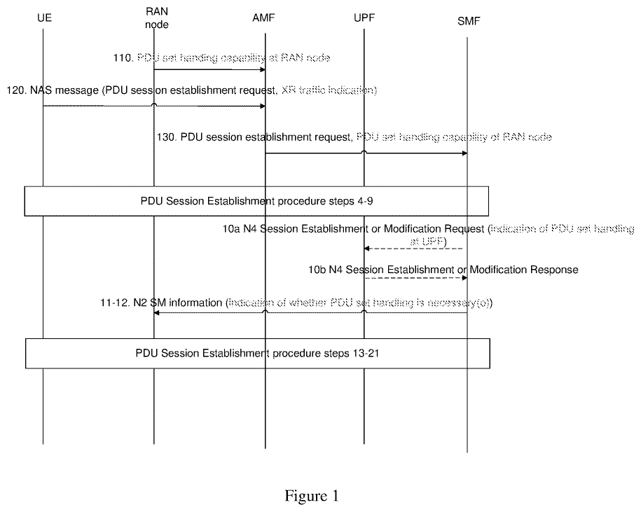

FIG. 1 illustrates the first sub-embodiment of the third embodiment.

In an optional step 110, RAN node (e.g. type #2 RAN node or type #3 RAN node) provides its PDU set handling capability to AMF during NG interface setup procedure. The PDU set handling capability of a RAN node provided to AMF can be ‘true’ (e.g. by type #3 RAN node) or ‘false’ (e.g. by type #2 RAN node). If no PDU set handling capability is provided to AMF during NG interface setup procedure by a RAN node (e.g. type #1 RAN node), AMF assumes that the PDU set handling capability of the RAN node is ‘false’.

In step 120, UE sends NAS message containing PDU session establishment request and XR traffic indication to AMF via a RAN node. The XR traffic indication instructs AMF to provide PDU set handling capability of the RAN node to SMF. The XR traffic indication is a new indication of providing traffic indication to lower layer (e.g. NAS layer in the first sub-embodiment) added into Route Selection Description associated with traffic description for XR traffic in UE Route Selection Policy. That is, if the application matches Traffic descriptor of specific URSP rule, based on the indication of providing XR traffic indication to lower layer, UE's URSP handling layer provides lower layer (e.g. NAS layer) the XR traffic indication.

AMF retrieves PDU set handling capability of the RAN node upon receiving the XR traffic indication contained in step 120. The PDU set handling capability of the RAN node may be provided in step 110, or determined as ‘false’ if the PDU set handling capability of the RAN node is not received in step 110. In step 130, AMF provides SMF with PDU session establishment request and PDU set handling capability of the RAN node.

The PDU session establishment request and the PDU set handling capability of the RAN node may be contained in Nsmf_PDUSession_CreateSMContext Request, or Nsmf_PDUSession_UpdateSMContext Request.

Step 120 and 130 corresponds to steps 1 and 3 of the PDU session establishment procedure. Incidentally, step 2 of the PDU session establishment procedure relates to AMF selecting SMF, which is not related to the present invention. Steps 4-21 of the PDU session establishment procedure will follow step 130. The first sub-embodiment has improvement on step 10 (e.g. step 10a is improved, while step 10b remains unchanged) of the PDU session establishment procedure. In particular, SMF determines the indication of PDU set handling at UPF for PDU session (e.g. the PDU session only carries XR traffic) or for specific QoS flow(s) (e.g. when only specific QoS flow(s) of the PDU session carry XR traffic) according to the received PDU set handling capability of the RAN node. That is, if the PDU set handling capability of the RAN node is ‘true’, the indication of PDU set handling at UPF for PDU session or for specific QoS flow(s) shall be ‘true’, while if the PDU set handling capability of the RAN node is ‘false’, the indication of PDU set handling at UPF for PDU session or for specific Qos flow(s) shall be ‘false’. In step 10a of the PDU session establishment procedure (i.e. after steps 4-9 of the PDU session establishment procedure), the indication of PDU set handling at UPF for PDU session or for specific QoS flow(s) is provided to UPF in the N4 session establishment or modification request. In step 10b of the PDU session establishment procedure, UPF sends N4 session establishment or modification response. Steps 11-21 of the PDU session establishment procedure are performed.

The first sub-embodiment may also have improvement on step 11-12 of the PDU session establishment procedure. In particular, SMF may optionally include the indication of whether PDU set handling is necessary in N2 SM information for RAN node via AMF.

According to a second sub-embodiment of the third embodiment, UE triggers the RAN node to provide PDU set handling capability of RAN node to SMF.

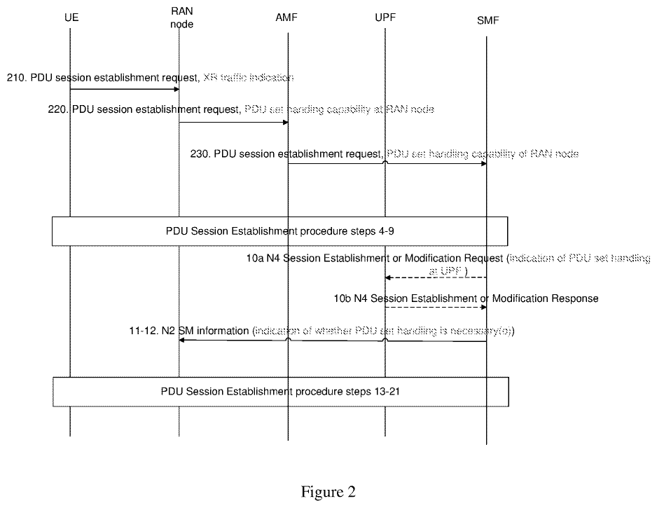

FIG. 2 illustrates the second sub-embodiment of the third embodiment.

In step 210. UE sends RRC message containing PDU session establishment request and XR traffic indication to RAN node. In the second sub-embodiment, the XR traffic indication is a new indication of providing traffic indication to lower layer (e.g. AS layer in the second sub-embodiment) added into Route Selection Description associated with traffic description for XR traffic in UE Route Selection Policy.

In step 220, RAN node forwards the PDU session establishment request and the PDU set handling capability of the RAN node to AMF. The PDU set handling capability of RAN node is provided in response to the reception of the XR traffic indication in step 210.

In step 230, the AMF provides SMF with PDU session establishment request and PDU set handling capability of the RAN node received in step 220.

Afterwards, the same steps as described with reference to FIG. 1 apply. Detailed description is omitted.

In the first and second sub-embodiments of the third embodiment, it is assumed that RAN node (e.g. type #2 RAN node or type #3 RAN node) understands new signaling or IEs introduced for XR traffic. In addition, RAN node notifies AMF of the PDU set handling capability proactively (e.g. in step 110 or in step 220).

According to a third sub-embodiment of the third embodiment, SMF checks PDU set handling capability of RAN node by itself.

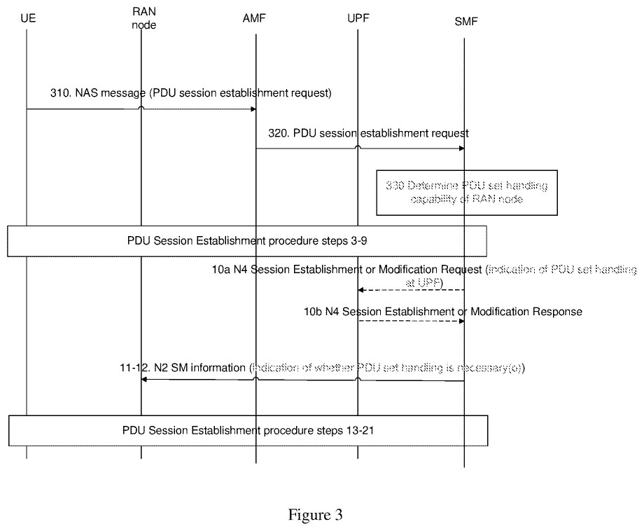

FIG. 3 illustrates the third sub-embodiment of the third embodiment.

In step 310, UE sends NAS message containing PDU session establishment request to AMF via a RAN node.

In step 320, AMF sends the PDU session establishment request to SMF.

In step 330, SMF determines the PDU set handling capability of RAN node. For example, SMF may determine the PDU set handling capability of RAN node according to the first embodiment or the second embodiment.

Afterwards, the same steps as described with reference to FIG. 1 or FIG. 2 apply. Detailed description is omitted.

According to a fourth embodiment of the third embodiment, RAN node responses SMF with PDU set handling indication upon XR-specific information provided by SMF.

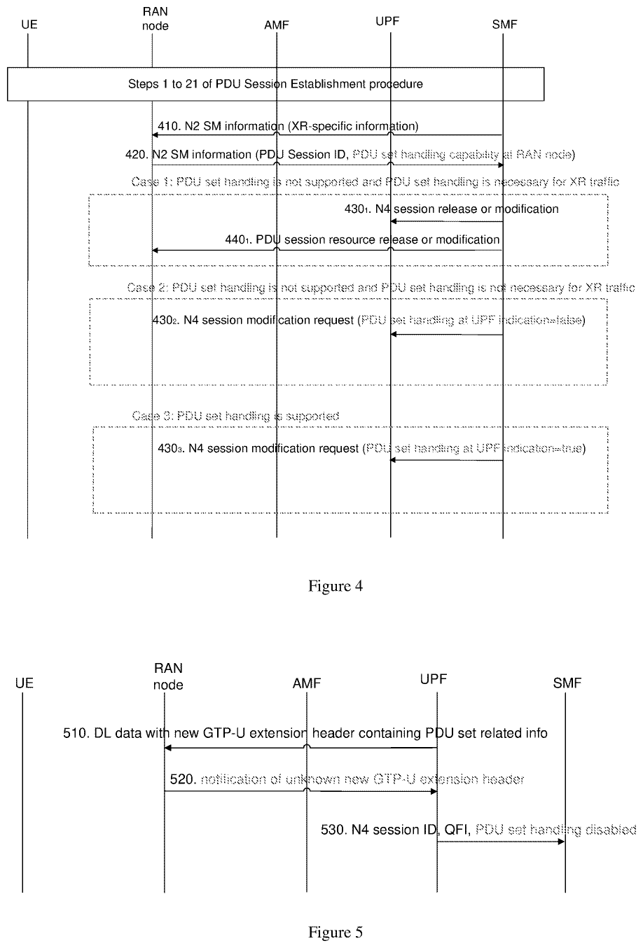

FIG. 4 illustrates the fourth sub-embodiment of the third embodiment.

First, PDU session establishment procedure (e.g. steps 1 to 21) is performed.

It is assumed that AF provides PFDs for XR traffic, which contains XR-specific information. As long as PCF provides application identifier in PCC rules, SMF retrieves PFD from UDR based on application identifier and recognizes XR traffic based on the XR-specific information contained in PFD. Alternatively, AF provides flow description for XR traffic, which contains XR-specific information. PCF provides SMF with PCC rule including flow description containing the XR traffic indication. It means that SMF can identify that the PDU session is established for XR traffic.

In Step 410, SMF sends N2 SM information to RAN node via AMF, which contains XR-specific information. The XR-specific information indicates that XR traffic will be transmitted in the PDU session or in specific QoS flow(s), and requires the RAN node to provide PDU set handling capability of the RAN node. The N2 SM information is PDU Session Resource Setup Request Transfer IE contained in PDU Session Resource Request Message sent from AMF to RAN node.

In step 420, upon receiving the XR-specific information, RAN node (e.g. type #2 RAN node or type #3 RAN node) sends a response (e.g. N2 SM information) containing the PDU set handling capability of the RAN node. The N2 SM information is PDU Session Resource Setup Response Transfer IE contained in PDU Session Resource Response Message sent from RAN node to SMF. On the other hand, type #1 RAN node cannot recognize the XR-specific information contained in N2 SM information, and accordingly does not send a response. Alternatively, type #1 RAN node may send a rejection to the N2 SM information (i.e. PDU Session Resource Setup Response Transfer IE) with a cause “unknown IEs”.

So, in step 420, SMF may receive a response, e.g. from type #3 RAN node, containing the PDU set handling capability of the RAN node as ‘true’, or receive a response, e.g. from type #2 RAN node, containing the PDU set handling capability of the RAN node as ‘false’, or does not receive any response or receive a rejection, e.g. from type #1 RAN node. If no response is received or the rejection is received in step 420, SMF determines that the RAN node does not support PDU set handling, i.e. the PDU set handling capability of the RAN node as ‘false’.

SMF determines what steps are performed according to the PDU set handling capability of the RAN node and whether PDU set handling is necessary.
Case 1: the PDU set handling capability of the RAN node is determined as ‘false’ (e.g. by receiving the response containing the PDU set handling capability of the RAN node as ‘false’ from type #2 RAN node, or by not receiving any response from type #1 RAN node) (i.e. PDU set handling is not supported), and PDU set handling is necessary (e.g. for XR traffic). In Case 1, steps 430₁ and 440₁ are performed. If all the QoS flows of the PDU session are used for XR traffic, in step 430₁. SMF triggers N4 session release procedure to release the PDU session. In step 440₁, SMF informs RAN node to release the PDU session. If only some of the QoS flows of the PDU session are used for XR traffic, in step 430₁, SMF triggers N4 session modification procedure to release the QoS flows for XR traffic. In step 440₁. SMF informs RAN node to release the QoS flows for XR traffic by PDU session modification message.
Case 2: the PDU set handling capability of the RAN node is determined as ‘false’ (e.g. by receiving the response containing the PDU set handling capability of the RAN node as ‘false’ from type #2 RAN node, or by not receiving any response from type #1 RAN node) (i.e. PDU set handling is not supported), and PDU set handling is not necessary (e.g. for XR traffic). In Case 2, step 430₂ is performed. In step 430₂, SMF triggers N4 session modification request procedure to deactivate PDU set handling at UPF, e.g. by setting PDU set handling indication in N4 session modification request as ‘false’.
Case 3: the PDU set handling capability of the RAN node is determined as ‘true’ (e.g. by receiving the response containing the PDU set handling capability of the RAN node as ‘true’ from type #3 RAN node) (i.e. PDU set handling is supported). In Case 3, step 430₃ is performed. In step 430₃, SMF triggers N4 session modification request procedure to activate PDU set handling at UPF, e.g. by setting PDU set handling indication in N4 session modification request as ‘true’.

The steps 410, 420, and 430₁ and 440₁, 430₂ or 430₃ can be considered as a part of the PDU session establishment procedure.

In the third embodiment, the PDU set handling capability of RAN node can be indicated in PDU session establishment procedure. Alternatively, the PDU set handling capability of RAN node can be indicated in PDU session modification procedure in a similar way to the above described first to fourth sub-embodiments of the third embodiment.

According to a fourth embodiment, if the RAN node does not support PDU set handling (i.e. the PDU set handling capability of RAN node is ‘false’), the RAN node make a response when receiving unknown new GTP-U extension header (e.g. for PDU set handling for XR traffic).

According to a first sub-embodiment of the fourth embodiment, the RAN node informs UPF that it does not support PDU set handling over user plane.

FIG. 5 illustrates the first sub-embodiment of the fourth embodiment.

In step 510, RAN node receives DL packets. RAN node finds that there is new unknown GTP-U extension header or new GTP-U extension header with PDU set related information.

In step 520, RAN node informs UPF that it does not support PDU set handling over user plane. For example, RAN node inserts PDU set handling indication in GTP-U header of UL packets, the value of which is ‘0’ or ‘false’ which implies that RAN node does not support PDU set handling.

Upon receiving the PDU set handling indication, UPF realizes that RAN node does not support PDU set handling. If there is no intermediate UPF (it means that UPF is PSA UPF), the PSA UPF stops PDU set identification and GTP-U header marking (i.e. stop PDU set handling at UPF).

If UPF is an intermediate UPF, the intermediate UPF informs the upstream UPF (e.g. another intermediate UPF, PSA UPF) that the RAN node does not support PDU set handling, until the PSA UPF realizes that RAN node does not support PDU set handling.

In addition, in step 530, UPF (e.g. PSA UPF) informs SMF that it has stopped PDU set handling for specific N4 session, or for (N4 session, QFI). By doing so, it is possible that SMF may inform UPF to restart PDU set identification and GTP-U header marking for a new RAN node which supports PDU set handling.

According to a second sub-embodiment of the fourth embodiment, the RAN node informs SMF that it does not support PDU set handling over control plane.

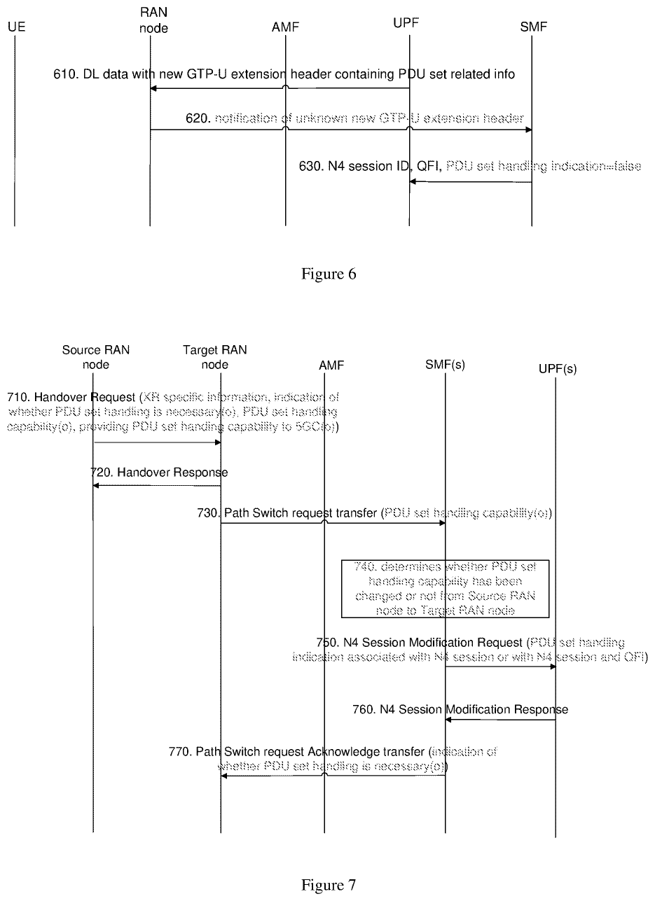

FIG. 6 illustrates the second sub-embodiment of the fourth embodiment.

In step 610, RAN node receives DL packets. RAN node finds that there is new unknown GTP-U extension header or new GTP-U extension header with PDU set related information.

In step 620, RAN node informs SMF that it does not support PDU set handling over control plane.

In step 630, SMF informs UPF (e.g. PSA UPF) to stop PDU set handling (i.e. PDU set identification and GTP-U header marking).

According to a fifth embodiment, the PDU set handling capability is indicated in a handover procedure between a source RAN node and a target RAN node.

It is assumed that the PDU set handling capability of the source RAN node and the PDU set handling capability of the target RAN node are different. If the PDU set handling capability of the source RAN node and the PDU set handling capability of the target RAN node are the same, there is no need to change the PDU set handling at UPF.

In a first sub-embodiment of the fifth embodiment, it is assumed that the source RAN node (e.g. type #3 RAN node) supports PDU set handling for XR traffic, and the target RAN node (e.g. type #1 RAN node or type #2 RAN node) does not support PDU set handling for XR traffic.

Since the source RAN node supports PDU set handling for XR traffic, SMF has informed UPF to perform PDU set identification and GTP-U header marking for XR traffic. Incidentally, if there are intermediate UPF(s), the PDU set identification and GTP-U header marking for XR traffic shall be performed at PSA UPF, and GTP-U header marking for XR traffic shall be performed at intermediate UPF(s).

FIG. 7 illustrates the first sub-embodiment of the fifth embodiment.

In step 710, source RAN node sends Handover Request message over Xn interface to target RAN node. XR specific information (e.g., PSDB, PSER etc.) associated with specific PDU session ID, or specific PDU session ID and QoS flow Identifier (QFI) is contained in Handover Request message. Any of the following messages can be optionally contained in the handover request message: 1) an indication of whether PDU set handling is necessary for XR traffic; 2) PDU set handling capability of the source RAN node; and (3) an indication to indicate target RAN node to provide PDU set handing capability of target RAN node to SMF.

In step 720, target RAN node sends Handover Response message to source RAN node.
Type #1 target RAN node ignores unknown IEs in Handover Request message. It means that type #1 target RAN node does not understand the XR specific information contained in the handover request. Type #1 target RAN node does not include any new indication in Path Switch Request Transfer.
Type #2 target RAN node understands the XR specific information contained in the handover request, and decides whether to include the PDU set handling capability in the Path Switch Request Transfer.
Type #2 target RAN node may decide to include the PDU set handling capability based on at least one of the following reasons:
(1) Target RAN node identifies XR traffic from the XR specific information associated with specific PDU session ID, or PDU session ID and QFI contained in Handover request.
(2) Target RAN node receives the indication of providing PDU set handling capability to 5GC (e.g. to SMF via AMF) from source RAN node.
(3) Target RAN node receives the PDU set handling capability of the source RAN node. Target RAN nodes determines that its PDU set handling capability is different from the PDU set handling capability of the source RAN node.

In step 730, target RAN node sends Path Switch Request Transfer to SMF via AMF. Path Switch Request Transfer is contained in Path Switch Request message in NG interface from Target RAN node to AMF. After that, it is contained in Nsmf_PDUSession_UpdateSMContext Request message from AMF to SMF.
Type #2 target RAN node sends Path Switch Request Transfer to SMF via AMF, which includes PDU set handling capability of the target RAN node (e.g. ‘false’). Type #1 target RAN node sends Path Switch Request Transfer to SMF via AMF, which does not include PDU set handling capability of the target RAN node.

In step 740, SMF determines whether PDU set handling capability has been changed or not from source RAN node to target RAN node.

First, SMF confirms that there is PDU session or QoS flow associated with XR traffic by checking UE context. For type #1 target RAN node that does not include any new indication (i.e. not include PDU set handling capability) in Path Switch Request Transfer in step 730, SMF determines that type #1 target RAN node does not support PDU set handling. For type #2 target RAN node, SMF determines that target RAN node does not support PDU set handling based on PDU set handling capability provided in step 730. Alternatively, SMF may determine the PDU set handling capability of the RAN node by itself, e.g. if the PDU set handling capability is not included in the Path Switch request transfer in step 730. For example, SMF may determine the PDU set handling capability of RAN node according to the first embodiment or the second embodiment.

When the SMF determines that the PDU set handling capability of the target RAN node (i.e. ‘false’) is different from the PDU set handling capability of the source RAN node (i.e. ‘true’), SMF determines that PDU set handling at UPF shall be deactivated. In step 750, SMF sends N4 session modification request including PDU set handling indication to UPFs (e.g. PSA UPF, intermediate UPF) to which target RAN node connects. In the first sub-embodiment of the fifth embodiment, the PDU set handling indication may only indicates that PDU set handling at UPF is deactivated for specific N4 session ID or (N4 session ID, QFI) that is associated with XR traffic. For example, the PDU set handling indication may be ‘false’ or ‘0’. It means that PDU set identification and GTP-U header marking for specific N4 session ID shall be stopped. N4 session ID is used between SMF and UPF, which has one to one mapping relationship with the PDU session ID used between SMF and RAN node (e.g. target RAN node). SMF has the mapping between PDU session ID and N4 session ID. Alternatively to provide the PDU set handling indication of ‘false’, if the PDU set handling indication is not provided in step 750, it means PDU set handling is not supported.

In step 760, UPF responds SMF with N4 Session Modification Response message.

In step 770, SMF responds target RAN node with Path Switch Request Acknowledge Transfer via AMF. Optionally, the Path Switch Request Acknowledge Transfer includes indication of whether PDU set handling is necessary (e.g. not necessary in the first sub-embodiment of the fifth embodiment).

In a second sub-embodiment of the fifth embodiment, it is assumed that the source RAN node (e.g. type #1 RAN node or type #2 RAN node) does not support PDU set handling for XR traffic, and the target RAN node (e.g. type #3 RAN node) supports PDU set handling for XR traffic.

Since the source RAN node does not support PDU set handling for XR traffic, SMF has not informed UPF to perform PDU set identification and GTP-U header marking for XR traffic. For example, SMF sends the indication of PDU set handling associated with N4 session ID, or (N4 session ID, QFI) to UPF, the value of which is ‘0’ or ‘false’. Alternatively, SMF does not send indication of PDU set handling to UPF.

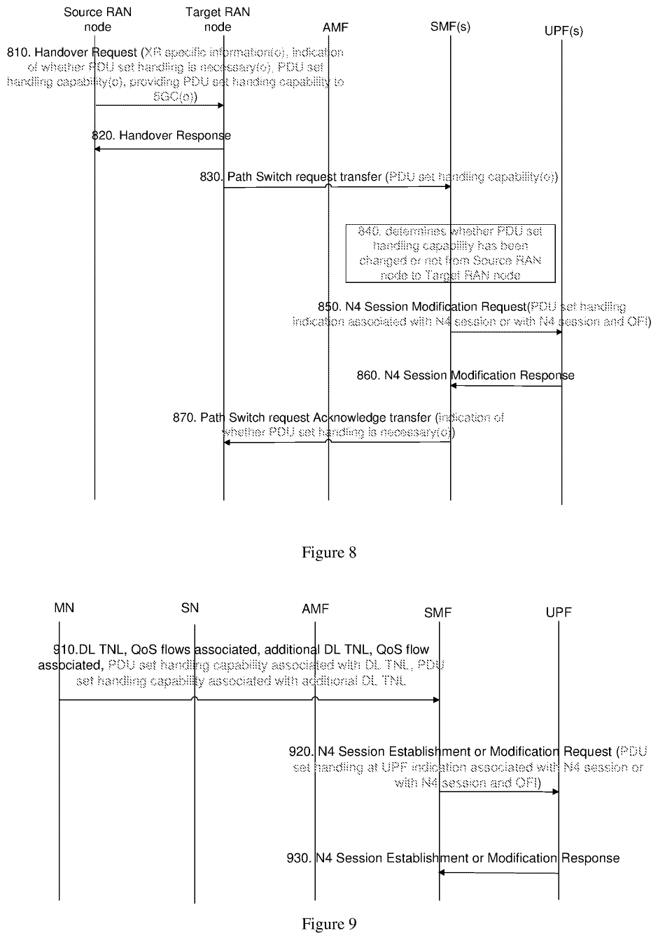

FIG. 8 illustrates the second sub-embodiment of the fifth embodiment.

In step 810, source RAN node sends Handover Request message over Xn interface to target RAN node. The Handover Request message sent by type #1 RAN node does not include XR specific information. The Handover Request message sent by type #2 RAN node may include XR specific information. Any of the following messages can also be optionally contained in the handover request message: 1) an indication of whether PDU set handling is necessary for XR traffic; 2) PDU set handling capability of the source RAN node; and (3) an indication to indicate target RAN node to provide PDU set handing capability of target RAN node to SMF.

In step 820, target RAN node sends Handover Response message to source RAN node.

In step 830, target RAN node sends Path Switch Request Transfer to SMF via AMF. The target RAN node may include its PDU set handling capability into Path Switch Request Transfer if it receives the XR specific information in step 810, or the target RAN node always include its PDU set handling capability into Path Switch Request Transfer. The target RAN node may not include its PDU set handling capability into Path Switch Request Transfer if it does not receive the XR specific information in step 810. The PDU set handling capability of Type #3 target RAN node is ‘true’.

In step 840, SMF determines whether PDU set handling capability has been changed or not from source RAN node to target RAN node.

First, SMF confirms that there is PDU session or QoS flow associated with XR traffic by checking UE context. If type #3 target RAN node includes PDU set handling capability in the Path Switch Request Transfer, SMF can makes determination according to the PDU set handling capability (i.e. ‘true’) included in the Path Switch Request Transfer. If type #3 target RAN node does not include PDU set handling capability in the Path Switch Request Transfer, SMF may requests target RAN node to provide its PDU set handling capability. Accordingly, target RAN node responds with its PDU set handling capability. New SMF related IE(s) between SMF and RAN node may be designed for the request and response of the PDU set handling capability. Alternatively, existing IEs between SMF and RAN node may be reused.

When the SMF determines that the PDU set handling capability of the target RAN node (i.e. ‘true) is different from the PDU set handling capability of the source RAN node (i.e. ‘false’), SMF determines that PDU set handling at UPF shall be activated. In step 850. SMF sends N4 session modification request including PDU set handling indication to UPFs (e.g. PSA UPF, intermediate UPF) to which target RAN node connects. In the second sub-embodiment of the fifth embodiment, the PDU set handling indication may only indicates that PDU set handling at UPF is activated for specific N4 session ID or (N4 session ID, QFI) that is associated with XR traffic. For example, the PDU set handling indication may be ‘true’ or ‘1’. It means that PDU set identification and GTP-U header marking for specific N4 session ID or (N4 session ID, QFI) shall be performed. Alternatively, if the type of PDU set handling is provided along with the PDU set handling capability, SMF may also inform UPF to map different types of PDU set of one application into different QoS flows, or to map all types of PDU set of one application into one QoS flow based on the type of PDU set handling.

In step 860, UPF responds SMF with N4 Session Modification Response message.

In step 870, SMF responds target RAN node with Path Switch Request Acknowledge Transfer via AMF. Optionally, the Path Switch Request Acknowledge Transfer includes indication of whether PDU set handling is necessary (e.g. not necessary in the second sub-embodiment of the fifth embodiment).

According to a sixth embodiment, the PDU set handling capability is indicated upon PDU session split at UPF in DC case.

Dual Connectivity (DC) is defined in TS 37.340. A UE connects to one RAN node, which is called master node (MN). MN is the radio access node that provides control plane connection to the core network. The UE also connects to another RAN node, which is called secondary node (SN). SN does not have control plane connection to the core network. UPF may split PDU session between MN and SN. It means that some QoS flow(s) of the PDU session are transferred to MN and other QoS flow(s) of the PDU session are transferred to SN.

For example, there are three QoS flows of the PDU session for XR traffic. At first, all QoS flows are transmitted to MN. It is supposed that MN supports PDU set integrated packet handling. So, SMF informs UPF to activate PDU set handling at UPF for all three QoS flows. It is supposed that MN decides to split the PDU session at UPF. For example, some QoS flow(s) (e.g. 2 QoS flows) of the PDU session are transferred to MN and other QoS flow(s) (e.g. 1 QoS flow) are transferred to SN from UPF. The first tunnel is between UPF and MN, and the second tunnel is between UPF and SN. If the PDU set handling capability of SN is different from the PDU set handling capability of MN (It is assumed that MN and SN exchanges their PDU set handling capabilities upon Xn setup or SN addition procedure), MN is necessary to inform the core network (e.g. SMF) that SN does not support PDU set integrated packet handling.

FIG. 9 illustrates the sixth embodiment.

In step 910, MN provides SMF with the PDU set handling capability for each tunnel of the PDU session. For example, when PDU session split is determined, MN provides PDU set handling capability associated with DL TNL and PDU set handling capability associated with additional DL TNL, in addition to PDU session ID, (DL TNL, QOS flow associated) and (additional DL TNL, QOS flow associated).

Alternatively, if it is assumed that the core network (e.g. SMF) has already known the PDU set handling capability of MN (e.g. according to any of the above-described first to fifth embodiments, when PDU session split is determined, MN only provides PDU set handling capability associated with additional DL TNL if the PDU set handling capability of SN (i.e. associated with additional DL TNL) is different from the PDU set handling capability of MN (i.e. associated with DL TNL).

For example, PDU set handling capability can be added into QoS Flow per TNL information defined in TS 38.413 9.3.2.8. PDU set handling capability can be in the form of ‘0’ (or ‘false’) indicating “not support of PDU set handling” or ‘1’ (or ‘true’) indicating “support of PDU set handling”.

TABLE 1
QoS Flow per TNL information

| | | | | |
|---|---|---|---|---|
| | | | IE type | |
| | Pres- | | and ref- | |
| IE/Group Name | ence | Range | erence | Semantics description |

| | | | |
|---|---|---|---|
| UP Transport Layer | M | 9.3.2.2 | |
| Information | | | |
| Associated QoS | M | 9.3.1.99 | |
| Flow List | | | |
| PDU set handling | O | | ‘0’ or ‘false’ |
| capability | | | means not support of |
| | | | PDU set handling, ‘1’ |
| | | | or ‘true’ means support |
| | | | of PDU set handling. |

Alternatively to always including PDU set handling capability, if PDU set handling capability is included, it means the PDU set handling at RAN node will be performed for the associated QoS flow(s). Otherwise (if PDU set handling capability is not included), it means the PDU set handling will not be performed for the associated QoS flow(s).

The QoS Flow per TNL information for the two tunnels may be contained in PDU Session Resource Modification Indication, or PDU Session Resource Setup Response, or PDU Session Resource Modification Response from MN to SMF.

In step 920, SMF informs UPF to activate or deactivate PDU set handling of specific QoS flow(s) of the N4 session by triggering N4 session establishment or modification procedure. Suppose that MN decides to offload QoS flow #3 to SN, SMF knows from step 910 that PDU set handling at SN will not be performed for QoS flow #3. Therefore, SMF informs UPF to stop PDU set handling for QFI=3 of the N4 session.

In step 930, UPF responds with N4 session establishment or modification response.

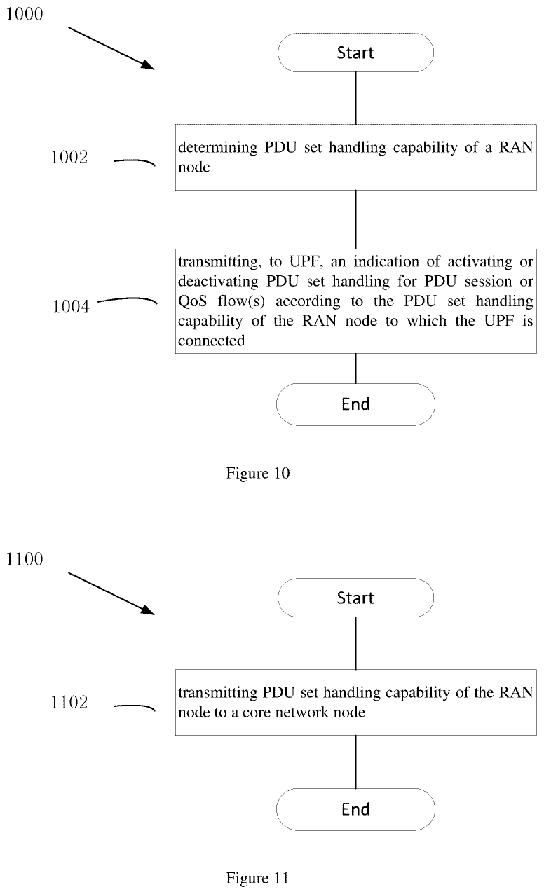

FIG. 10 is a schematic flow chart diagram illustrating an embodiment of a method 1000 according to the present application. In some embodiments, the method 1000 is performed by a network function such as an SMF or a network function with an SMF. In certain embodiments, the method 1000 may be performed by a processor executing program code, for example, a microcontroller, a microprocessor, a CPU, a GPU, an auxiliary processing unit, a FPGA, or the like.

The method 1000 may comprise: 1002 determining PDU set handling capability of a RAN node; and 1004 transmitting, to UPF, an indication of activating or deactivating PDU set handling for PDU session or QoS flow(s) according to the PDU set handling capability of the RAN node to which the UPF is connected.

In some embodiment, the PDU set handling comprises PDU set identification and GTP-U header marking at PSA UPF, or GTP-U header marking at intermediate UPF.

In some embodiment, the PDU set handling capability of the RAN node is determined based on at least one of RAN node's ID, area information, and a combination of DNN and S-NSSAI.

In some embodiment, the PDU set handling capability of the RAN node is determined by retrieving the PDU set handling capability of the RAN node from NRF.

In some embodiment, the PDU set handling capability of the RAN node is determined by receiving the PDU set handling capability of the RAN node during PDU session establishment procedure.

In some embodiment, the PDU set handling capability of RAN node is determined as not support of PDU set integrated packet handling by receiving an indication that unknown GTP-U extension header is found.

In some embodiment, the PDU set handling capability of the RAN node is determined by receiving the PDU set handling capability of the RAN node contained in Path Switch Request Transfer.

In some embodiment, the RAN node is a target RAN node in Handover, and if it is determined that the PDU set handling capability of the target RAN node is different from the PDU set handling capability of a source RAN node, the indication is transmitted to the UPF.

In some embodiment, the PDU set handling capability of a secondary RAN node is determined by receiving the PDU set handling capability of the secondary RAN node from a master RAN node.

In some embodiment, the method further comprises sending to the RAN node an indication of whether PDU set handling is necessary.

FIG. 11 is a schematic flow chart diagram illustrating an embodiment of a method 1100 according to the present application. In some embodiments, the method 1100 is performed by a network node such as a RAN node (e.g. NG-RAN node). In certain embodiments, the method 1100 may be performed by a processor executing program code, for example, a microcontroller, a microprocessor, a CPU, a GPU, an auxiliary processing unit, a FPGA, or the like.

The method 1100 may comprise 1102 transmitting PDU set handling capability of the RAN node to a core network node.

In some embodiment, the PDU set handling capability of the RAN node is transmitted to SMF via AMF.

In some embodiment, the PDU set handling capability of the RAN node is transmitted in response to a request from SMF.

In some embodiment, the PDU set handling capability of the RAN node is transmitted to UPF or SMF in response to receiving a DL packet which contains unknown new GTP-U extension header.

In some embodiment, the PDU set handling capability of the RAN node is transmitted in response to at least one of: receiving XR specific information contained in Handover Request; receiving an indication of providing PDU set handling capability; and determining that the PDU set handling capability of the RAN node is different from the PDU set handling capability of source RAN node in Handover.

In some embodiment, the method further comprises: transmitting PDU set handling capability of a secondary RAN node to the core network node.

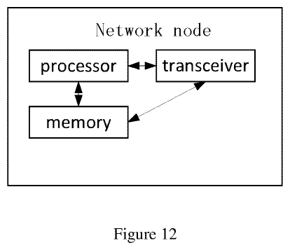

FIG. 12 is a schematic block diagram illustrating apparatuses according to one embodiment.

The network function or network node or network entity (e.g. SMF or RAN node) includes a processor, a memory, and a transceiver. The processor implements a function, a process, and/or a method which are proposed in FIG. 10 or 11.

SMF comprises a processor and a transceiver coupled to the processor, wherein the processor is configured to determine PDU set handling capability of a RAN node; and transmit, via the transceiver, to UPF, an indication of activating or deactivating PDU set handling for PDU session or QoS flow(s) according to the PDU set handling capability of the RAN node to which the UPF is connected.

In some embodiment, the PDU set handling comprises PDU set identification and GTP-U header marking at PSA UPF, or GTP-U header marking at intermediate UPF.

In some embodiment, the PDU set handling capability of the RAN node is determined based on at least one of RAN node's ID, area information, and a combination of DNN and S-NSSAI.

In some embodiment, the PDU set handling capability of the RAN node is determined by retrieving the PDU set handling capability of the RAN node from NRF.

In some embodiment, the PDU set handling capability of the RAN node is determined by receiving, via the transceiver, the PDU set handling capability of the RAN node during PDU session establishment procedure.

In some embodiment, the PDU set handling capability of RAN node is determined as not support of PDU set integrated packet handling by receiving, via the transceiver, an indication that unknown GTP-U extension header is found.

In some embodiment, the PDU set handling capability of the RAN node is determined by receiving, via the transceiver, the PDU set handling capability of the RAN node contained in Path Switch Request Transfer.

In some embodiment, the RAN node is a target RAN node in Handover, and if the processor determines that the PDU set handling capability of the target RAN node is different from the PDU set handling capability of a source RAN node, the indication is transmitted to the UPF.

In some embodiment, the PDU set handling capability of a secondary RAN node is determined by receiving, via the transceiver, the PDU set handling capability of the secondary RAN node from a master RAN node.

In some embodiment, the processor is further configured to send, via the transceiver, to the RAN node, an indication of whether PDU set handling is necessary.

The RAN node comprises a processor and a transceiver coupled to the processor, wherein the processor is configured to transmit, via the transceiver, PDU set handling capability of the RAN node to a core network node.

In some embodiment, the PDU set handling capability of the RAN node is transmitted to SMF via AMF.

In some embodiment, the PDU set handling capability of the RAN node is transmitted in response to a request from SMF.

In some embodiment, the PDU set handling capability of the RAN node is transmitted to UPF or SMF in response to receiving a DL packet which contains unknown new GTP-U extension header.

In some embodiment, the PDU set handling capability of the RAN node is transmitted in response to at least one of: receiving XR specific information contained in Handover Request; receiving an indication of providing PDU set handling capability; and determining that the PDU set handling capability of the RAN node is different from the PDU set handling capability of source RAN node in Handover.

In some embodiment, the processor is further configured to transmit, via the transceiver, PDU set handling capability of a secondary RAN node to the core network node.

Layers of a radio interface protocol may be implemented by the processors. The memories are connected with the processors to store various pieces of information for driving the processors. The transceivers are connected with the processors to transmit and/or receive message or information. Needless to say, the transceiver may be implemented as a transmitter to transmit the information and a receiver to receive the information.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1. A network entity to implement a session management function (SMF), the network entity comprising:
at least one memory; and
at least one processor coupled with the at least one memory and configured to cause the network entity to:
determine a Protocol Data Unit (PDU) set handling capability of a Radio Access Network (RAN) node; and
transmit, to a User Plane Function (UPF), an indication of activating PDU set handling for a PDU session or one or more Quality of Service (QOS) flows according to the PDU set handling capability of the RAN node.

2. The network entity of claim 1, wherein, the PDU set handling comprises PDU set identification and General Packet Radio Service (GPRS) Tunnelling Protocol User Plane (GTP-U) header marking.

3. The network entity of claim 1, wherein, the PDU set handling capability of the RAN node is determined based on at least one of an identity of the RAN node, area information, or a combination of Data Network Name (DNN) and Single Network Slice Selection Assistance Information (S-NSSAI).

4. The network entity of claim 1, wherein, the PDU set handling capability of the RAN node is determined by retrieving the PDU set handling capability of the RAN node from a Network Repository Function (NRF).

5. The network entity of claim 1, wherein, the PDU set handling capability of the RAN node is determined based at least in part on receiving the PDU set handling capability of the RAN node during a PDU session establishment procedure.

6. The network entity of claim 1, wherein, the PDU set handling capability of the RAN node is determined to not support PDU set integrated packet handling based at least in part on receiving an indication that an unknown General Packet Radio Service (GPRS) Tunnelling Protocol User Plane (GTP-U) extension header is found.

7. The network entity of claim 1, wherein, the PDU set handling capability of the RAN node is determined based at least in part on receiving the PDU set handling capability of the RAN node included in a Path Switch Request Transfer.

8. The network entity of claim 1, wherein:
the RAN node comprises a target RAN node; and
the indication of activating the PDU set handling for the PDU session is transmitted based at least in part on determining that a PDU set handling capability of the target RAN node is different from a PDU set handling capability of a source RAN node.

9. The network entity of claim 1, wherein, a PDU set handling capability of a secondary RAN node is determined by receiving the PDU set handling capability of the secondary RAN node from a master RAN node.

10. The network entity of claim 1, the at least one processor is configured to cause the network entity to send, to the RAN node, an indication of whether PDU set handling is necessary.

11. A method performed at a session management function (SMF), comprising:
determining a Protocol Data Unit (PDU) set handling capability of a Radio Access Network (RAN) node; and
transmitting, to User Plane Function (UPF), an indication of activating PDU set handling for a PDU session or one or more Quality of Service (QOS) flows according to the PDU set handling capability of the RAN node.

12. A Radio Access Network (RAN) node for wireless communication, comprising:
at least one memory; and
at least one processor coupled with the at least one memory and configured to cause the RAN node to:
transmit a Protocol Data Unit (PDU) set handling capability of the RAN node to a core network node.

13. The RAN node of claim 12, wherein, the PDU set handling capability of the RAN node is transmitted to a session management function (SMF) via an Access and Mobility Management Function (AMF).

14. The RAN node of claim 12, wherein, the PDU set handling capability of the RAN node is transmitted in response to a request from a session management function (SMF).

15. The RAN node of claim 12, wherein, the PDU set handling capability of the RAN node is transmitted in response to at least one of:
receiving Extended Reality (XR) specific information included in a handover request;
receiving an indication of providing PDU set handling capability; or
determining that the PDU set handling capability of the RAN node is different from a PDU set handling capability of a source RAN node in a handover.

16. A processor for wireless communication, comprising:
at least one controller coupled with at least one memory and configured to cause the processor to:
determine a Protocol Data Unit (PDU) set handling capability of a Radio Access Network (RAN) node; and
transmit, to a User Plane Function (UPF), an indication of activating PDU set handling for a PDU session or one or more Quality of Service (QOS) flows according to the PDU set handling capability of the RAN node.

17. The processor of claim 16, wherein, the PDU set handling comprises PDU set identification and General Packet Radio Service (GPRS) Tunnelling Protocol User Plane (GTP-U) header marking.

18. The processor of claim 16, wherein, the PDU set handling capability of the RAN node is determined based at least in part on receiving the PDU set handling capability of the RAN node during a PDU session establishment procedure.

19. The processor of claim 16, wherein, the PDU set handling capability of the RAN node is determined based at least in part on receiving the 17 PDU set handling capability of the RAN node included in a Path Switch Request 18 Transfer.

20. The processor of claim 16, wherein:
the RAN node comprises a target RAN node; and
the indication of activating the PDU set handling for the PDU session is transmitted based at least in part on determining that a PDU set handling capability of the target RAN node is different from a PDU set handling capability of a source RAN node.
